(19) United States
(12) Patent Application Publication
(10) Pub. No.: US 2021/0359617 A1
(43) Pub. Date: Nov. 18, 2021

(54) ELECTRICAL ASSEMBLY

(71) Applicant: GENERAL ELECTRIC TECHNOLOGY GMBH, Baden (CH)

(72) Inventors: Chandra Mohan Sonnathi, Stafford (GB); Radnya Anant Mukhedkar, Stafford (GB); Rajaseker Reddy Ginnareddy, Stafford (GB); Amit Kumar, Stafford (GB); Damien Pierre Gilbert Fonteyne, Stafford (GB)

(21) Appl. No.: 16/982,693

(22) PCT Filed: Mar. 20, 2019
(86) PCT No.: PCT/EP2019/056955

§ 371 Date: Sep. 21, 2020

(30) Foreign Application Priority Data
Mar. 21, 2018 (EP) 18163073.2

(51) Int. Cl. H02M 5/458; H02J 3/36; H02M 1/32; H02M 7/219

(52) U.S. Cl. CPC H02M 5/4585; H02M 7/219; H02M 1/322; H02J 3/36

(57) ABSTRACT

There is provided an electrical assembly (20) for interconnecting first and second networks (40). The electrical assembly (20) comprises a power transmission medium (36,38) and a converter (22), the power transmission medium (36,38) configured for connection to the first network, the converter (22) including: a first terminal (24,26) and a second terminal (34), the first terminal (24,26) connected to the power transmission medium (36,38), the second terminal (34) configured for connection to the second network (40); at least one switching module (44) arranged to interconnect the first terminal (24,26) and the second terminal (34), the or each switching module (44) switchable to control a transfer of power between the first and second networks (40); at least one discharge circuit including a discharge switching element (50) and a discharge resistor (52), the or each discharge switching element (50) switchable to switch the corresponding discharge resistor (52) into and out of the converter (22); and a controller (58) configured to selectively control the switching of the or each discharge switching element (50) to form a current path (60) in the converter (22), the current path including the or each discharge resistor (22), so that a discharging current flows through the current path to discharge an energy stored in the power transmission medium (36,38).

This invention relates to an electrical assembly for interconnecting first and second networks, preferably for use in high voltage direct current (HVDC) transmission.

In HVDC power transmission networks alternating current (AC) power is typically converted to direct current (DC) power for transmission via overhead lines, under-sea cables and/or underground cables. This conversion removes the need to compensate for the AC capacitive load effects imposed by the power transmission medium, i.e. the transmission line or cable, and reduces the cost per kilometre of the lines and/or cables, and thus becomes cost-effective when power needs to be transmitted over a long distance.

The conversion between DC power and AC power is utilized in power transmission networks where it is necessary to interconnect the DC and AC networks. In any such power transmission network, converters are required at each interface between AC and DC power to effect the required conversion from AC to DC or from DC to AC.

According to an aspect of the invention, there is provided an electrical assembly for interconnecting first and second networks, the electrical assembly comprising a power transmission medium and a converter, the power transmission medium configured for connection to the first network, the converter including:
a first terminal and a second terminal, the first terminal connected to the power transmission medium, the second terminal configured for connection to the second network;
at least one switching module arranged to interconnect the first terminal and the second terminal, the or each switching module switchable to control a transfer of power between the first and second networks;
at least one discharge circuit including a discharge switching element and a discharge resistor, the or each discharge switching element switchable to switch the corresponding discharge resistor into and out of the converter; and
a controller configured to selectively control the switching of the or each discharge switching element to form a current path in the converter, the current path including the or each discharge resistor, so that a discharging current flows through the current path to discharge an energy stored in the power transmission medium.

The converter may include a single first terminal or a plurality of first terminals. The converter may include a single second terminal or a plurality of second terminals. The converter may be, for example, a rectifier, an inverter, an AC-AC converter, or a DC-DC converter.

The above configuration of the electrical assembly of the invention enables fast discharge of the energy stored in the power transmission medium through the control of the or each discharge circuit internal to the converter.

In addition, the above configuration of the electrical assembly of the invention results in an electrical assembly with reduced costs and footprint in comparison to a conventional electrical assembly with a dedicated discharge circuit which is connected to the power transmission medium and external to the converter. This is because the dedicated discharge circuit is not only required to withstand voltage and insulation levels which are comparable to voltage and insulation levels of the power transmission medium but also required to have a switching apparatus capable of continuously withstanding a voltage of the power transmission medium, thus increasing the size and footprint of the conventional electrical assembly. Furthermore, the required number of dedicated discharge circuits increases with the number of power transmission media in the conventional electrical assembly, while the number of discharge circuits (i.e. one or more) in the electrical assembly of the invention is not dependent on the number of power transmission media.

In a preferred embodiment of the invention, the controller is configured to selectively control the switching of the or each discharge switching element to form the current path in response to an occurrence of an electrical fault or disturbance.

In a further preferred embodiment of the invention, the controller is configured to selectively control the switching of the or each discharge switching element to form the current path in response to a DC over-voltage or an AC over-frequency in the power transmission medium, the first network or the second network.

The electrical fault or disturbance may occur in, for example, the converter, the power transmission medium, the first network, or the second network. Also, the electrical fault or disturbance may result in: a DC over-voltage; an AC over-frequency; an overcurrent; a power swing; and/or an imbalance between a power fed to the electrical assembly (e.g. a power generated by one or more associated sources) and a power demanded of the electrical assembly (e.g. a power demanded by one or more associated loads). Configuring the controller in this manner enables the discharge of the energy stored in the power transmission medium so as to protect the converter and power transmission medium from adverse consequences arising from the fault.

In another preferred embodiment of the invention, the controller is configured to selectively control the switching of the or each discharge switching element to form the current path under normal operating conditions of the electrical assembly. Configuring the controller in this manner enables the discharge of the energy stored in the power transmission medium so as to, for example, carry out maintenance of the electrical assembly.

It will be understood that the electrical assembly under normal operating conditions does not experience any electrical fault or disturbance. A shutdown of the electrical assembly under normal operating conditions is not carried out in response to an electrical fault or disturbance, but is instead carried out in response to, for example, an operator decision, or the need to perform maintenance of the electrical assembly.

Prior to forming the current path for the discharging current, the converter may be pre-configured to allow for a more effective discharge of the energy stored in the power transmission medium. The controller may be configured to selectively control the switching of the or each switching module to block the converter prior to the control of the switching of the or each discharge switching element to form the current path.

Alternatively, the converter may be configured so that, when the current path for the discharging current is formed, the electrical assembly is configured to ride through an electrical fault or disturbance in order to adhere to grid codes that require the electrical assembly to stay online. For example, the controller may be configured to selectively control the switching of the or each switching module to de-block the converter or maintain the converter in a de-blocked state prior to the control of the switching of the or each discharge switching element to form the current path.

The electrical assembly may include a first circuit interruption device connected to the first terminal and configured for connection to the first network, wherein the electrical assembly may include a first control unit configured to selectively operate the first circuit interruption device to disconnect the converter from the first network prior to the control of the switching of the or each discharge switching element to form the current path. This enables isolation of the converter from the first network prior to the formation of the current path to carry out the discharging of the energy stored in the power transmission medium.

Also, when the electrical assembly includes a second circuit interruption device connected to the second terminal and configured for connection to the second network, the electrical assembly may include a second control unit configured to selectively operate the second circuit interruption device to disconnect the converter from the second network prior to the control of the switching of the or each discharge switching element to form the current path. This enables isolation of the converter from the second network prior to the formation of the current path to carry out the discharging of the energy stored in the power transmission medium.

On the other hand, the electrical assembly may be configured to maintain electrical connection of the converter to the first and second networks when the or each discharge circuit is controlled to form the current path. The discharging function provided by the formation of the current path helps the electrical assembly to ride through an electrical fault or disturbance and thereby adhere to grid codes that require the electrical assembly to stay online.

To maintain the electrical connection of the converter to the first network, the electrical assembly may include a first circuit interruption device connected to the first terminal and configured for connection to the first network, wherein the electrical assembly may include a first control unit configured to selectively operate the first circuit interruption device to maintain the electrical connection between the converter and the first network when the or each discharge circuit is controlled to form the current path.

To maintain the electrical connection of the converter to the second network, the electrical assembly may include a second circuit interruption device connected to the second terminal and configured for connection to the second network, wherein the electrical assembly may include a second control unit configured to selectively operate the second circuit interruption device to maintain the electrical connection between the converter and the second network when the or each discharge circuit is controlled to form the current path.

The energy stored in the power transmission medium may be discharged by directing the discharging current through the current path extending from the first terminal to the second terminal. For example, in further embodiments of the invention, the controller may be configured to selectively control the switching of the or each discharge switching element to connect the current path to the second terminal so that the discharging current flows to the second terminal. In such embodiments, the electrical assembly may include at least one impedance element operably connected to the second terminal. The or each impedance element may be a grounding impedance element. The or each impedance element may include a linear resistive element, a non-linear resistive element and/or a reactance element.

The or each switching module may vary in configuration so long as the or each switching module is capable of performing a switching function to control a transfer of power between the first and second networks.

In a preferred embodiment of the invention, the or each switching module may include at least one module switching element and at least one energy storage device, the or each module switching element and the or each energy storage device in the or each switching module arranged to be combinable to selectively provide a voltage source, wherein the or each discharge circuit may be arranged in the switching module or a respective one of the switching modules. In such embodiments, the or each discharge circuit may be connected in parallel with the or each energy storage device of the switching module or the or each energy storage device of the respective one of the switching modules.

In another preferred embodiment of the invention, the or each switching module may include at least one module switching element and at least one energy storage device, the or each module switching element and the or each energy storage device in the or each switching module arranged to be combinable to selectively provide a voltage source, wherein the or each discharge circuit may be connected in parallel with the switching module or a respective one of the switching modules.

Optionally the controller may be configured to selectively control the switching of the or each discharge switching element to electrically connect the or each discharge resistor to the or each corresponding energy storage device so as to discharge an energy stored in the or each corresponding energy storage device.

The or each discharge circuit may be used to not only selectively discharge the energy stored in the power transmission medium, but also selectively discharge energy stored in the or each energy storage device of the corresponding module. The latter feature may be used to rapidly discharge the or each energy storage device in order to, for example, permit fast access to the or each switching module for repair or maintenance. Increasing the functionality of the or each discharge circuit advantageously improves the efficiency of the converter.

It will be understood that it is not essential for the or each discharge circuit to form part of a switching module.

The or each switching module in the converter may vary in configuration.

In a first exemplary configuration of a switching module, the or each module switching element and the or each energy storage device in the switching module may be arranged to be combinable to selectively provide a unidirectional voltage source. For example, the switching module may include a pair of module switching elements connected in parallel with an energy storage device in a half-bridge arrangement to define a 2-quadrant unipolar module that can provide zero or positive voltage and can conduct current in two directions.

In a second exemplary configuration of a switching module, the or each module switching element and the or each energy storage device in the switching module may be arranged to be combinable to selectively provide a bidirectional voltage source. For example, the switching module may include two pairs of module switching elements connected in parallel with an energy storage device in a full-bridge arrangement to define a 4-quadrant bipolar module that can provide negative, zero or positive voltage and can conduct current in two directions.

A plurality of switching modules may be connected in series to define a chain-link converter. The structure of the chain-link converter permits build-up of a combined voltage across the chain-link converter, which is higher than the voltage available from each of its individual switching modules, via the insertion of the energy storage devices of multiple switching modules, each providing its own voltage, into the chain-link converter. In this manner switching of the or each module switching element in each switching module causes the chain-link converter to provide a stepped variable voltage source, which permits the generation of a voltage waveform across the chain-link converter using a step-wise approximation. As such the chain-link converter is capable of providing a wide range of complex voltage waveforms.

Alternatively, the or each switching module may include one or more switching elements but omit any energy storage device.

At least one switching element may include at least one self-commutated switching device. The or each self-commutated switching device may be an insulated gate bipolar transistor, a gate turn-off thyristor, a field effect transistor, an injection-enhanced gate transistor, an integrated gate commutated thyristor or any other self-commutated switching device. The number of switching devices in each switching element may vary depending on the required voltage and current ratings of that switching element.

At least one switching element may further include a passive current check element that is connected in anti-parallel with the or each switching device. The or each passive current check element may include at least one passive current check device. The or each passive current check device may be any device that is capable of limiting current flow in only one direction, e.g. a diode. The number of passive current check devices in each passive current check element may vary depending on the required voltage and current ratings of that passive current check element.

Each energy storage device may be any device that is capable of storing and releasing energy to selectively provide a voltage, e.g. a capacitor, fuel cell or battery.

The first terminal may be a DC terminal. In such embodiments, the electrical assembly may form or include part of a symmetrical monopole, asymmetrical monopole, bipolar, or homopolar power transmission scheme, or any other type of DC power transmission scheme.

The second terminal may be an AC terminal.

The energy stored in the power transmission medium may be discharged by directing the discharging current through the current path extending from a first terminal to another first terminal. For example, in embodiments of the invention, the converter may include a pair of first terminals defining first and second DC terminals, the first DC terminal connected to the power transmission medium, the second DC terminal configured for connection to another power transmission medium or ground, wherein the controller may be configured to selectively control the switching of the or each discharge switching element to form the current path to connect the DC terminals so that the discharging current flows between the DC terminals.

Alternatively, the first terminal may be an AC terminal.

The configuration of the converter may vary depending on the requirements of the power transfer between the first and second networks.

In embodiments of the invention, the converter may include at least one converter limb and a plurality of switching modules, the or each converter limb extending between a pair of first terminals defining first and second DC terminals, the or each converter limb including first and second limb portions separated by a second terminal defining an AC terminal, each limb portion including at least one of the switching modules, wherein the controller may be configured to selectively control the switching of the or each discharge switching element to form the current path so that the discharging current flows through at least one or both of the limb portions of the or each converter limb.

The exact configuration of the current path through the or each converter limb depends on the energy discharge requirements of the power transmission medium.

In a preferred embodiment of the invention, the converter includes three converter limbs, each of which is connectable via the respective AC terminal to a respective phase of a three-phase AC network. It will be appreciated that the converter may include a different number of converter limbs, each of which is connectable via the respective AC terminal to a respective phase of an AC network with the corresponding number of phases.

Optionally the converter may include one or more grounding connections, the or each grounding connection including a grounding switching element switchable to selectively connect the converter to ground, and the controller may be further configured to selectively control the switching of the or each grounding switching element to connect the current path to ground via the or each grounding connection. The inclusion of one or more grounding connections internal to the converter provides a reliable means of connecting the current path to ground in order to enable the fast discharge of the energy stored in the power transmission medium.

In such embodiments, the first and second terminals may respectively define AC and DC terminals or DC and AC terminals, and the or each grounding connection may be arranged at an AC side or a DC side of the converter.

In embodiments of the invention employing the use of the or each impedance element and the or each grounding connection, the or each impedance element may include a non-linear resistive element, and the controller may be configured to selectively control the switching of the or each discharge switching element and the or each grounding switching element to connect the current path to the second terminal so that the discharging current flows through the or each impedance element followed by connecting the current path to ground via the or each grounding connection.

When the discharging current flows through the non-linear resistive element, the energy stored in the power transmission medium will be discharged until a voltage of the power transmission medium reaches a protective level of the non-linear resistive element. It is therefore beneficial to then connect the current path to ground via the or each grounding connection in order to discharge the remaining energy stored in the power transmission medium.

In circumstances in which a power fed to the electrical assembly (e.g. a power generated by one or more associated sources) exceeds a power demanded of the electrical assembly (e.g. a power demanded by one or more associated loads), the electrical assembly may be configured to discharge excess power fed to the electrical assembly, which is the difference between the power fed to the electrical assembly and the power demanded of the electrical assembly. This is achieved by configuring the controller to selectively control the switching of the or each discharge switching element to form the current path in the converter so that a discharging current flows through the current path to discharge an energy stored in the power transmission medium so as to dissipate excess power fed to the electrical assembly.

In embodiments of the invention, the controller may be configured to determine an allowable duration of forming the current path, wherein the allowable duration may be determined as a function of a power transfer level of the electrical assembly, an amount of power required to be dissipated by the or each discharge circuit and/or an energy rating of the or each discharge circuit. This allows the controller to determine how long the discharging function of the current path can help the electrical assembly to ride through an electrical fault or disturbance before the electrical assembly needs to be taken offline in order to ensure the safety of the electrical assembly and the associated networks.

In the event that a duration of an electrical fault or disturbance associated with the electrical assembly exceeds the allowable duration of forming the current path, the electrical assembly may be configured to be offline in order to ensure the safety of the electrical assembly and the associated networks.

Optionally the controller may be configured to selectively control the switching of the or each switching module to block the converter in response to a duration of an electrical fault or disturbance associated with the electrical assembly exceeding the allowable duration of forming the current path.

Further optionally, when the electrical assembly includes a first circuit interruption device connected to the first terminal and configured for connection to the first network, the electrical assembly may include a first control unit configured to selectively operate the first circuit interruption device to disconnect the converter from the first network in response to a duration of an electrical fault or disturbance associated with the electrical assembly exceeding the allowable duration of forming the current path.

Even further optionally, when the electrical assembly includes a second circuit interruption device connected to the second terminal and configured for connection to the second network, the electrical assembly may include a second control unit configured to selectively operate the second circuit interruption device to disconnect the converter from the second network in response to a duration of an electrical fault or disturbance associated with the electrical assembly exceeding the allowable duration of forming the current path.

The electrical assembly of the invention may include the provision of multiple discharge circuits to form multiple current paths.

In embodiments of the invention, the converter may include a plurality of discharge circuits, and the controller may be configured to selectively control the switching of the discharge switching elements of the discharge circuits to form respective current paths in the converter.

In further embodiments of the invention, the electrical assembly may include a plurality of converters, each converter including at least one discharge circuit, wherein the controller may be configured to selectively control the switching of the discharge switching elements of the discharge circuits to form respective current paths in the respective converters.

In such embodiments, a first one of the plurality of converters may be configured as a rectifier, and a second one of the plurality of converters may be configured as an inverter. The first terminal of the rectifier may be an AC terminal, the second terminal of the rectifier may be a DC terminal, the first terminal of the inverter may be a DC terminal, and the second terminal of the inverter may be an AC terminal.

In still further embodiments of the invention, the controller may be configured to control the switching of the discharge switching elements of the discharge circuits to form the respective current paths by varying a respective trigger level or range at which each discharge circuit is controlled to form the respective current path.

Configuring the controller in this manner enables the electrical assembly to dynamically modify the respective trigger level or range at which each discharge circuit is controlled to form the respective current path. This enables the distribution of the discharging function between the various current paths so as to optimise the discharging of energy from the or each power transmission medium, which can be beneficial for adapting to a wide range of conditions of the electrical assembly, the first network and the second network.

Furthermore, when the electrical assembly includes a plurality of converters (e.g. at least one rectifier and at least one inverter), such configuration of the controller enables the electrical assembly to control the distribution of the discharging function between the plurality of converters to not only optimise the discharging of energy from the or each power transmission medium but also enable one or more of the plurality of converters to readily provide reactive power support to an associated AC network.

Preferably the trigger levels or ranges of the discharge circuits are varied so as to coordinate the control of the discharge circuits to form the respective current paths. Even more preferably, the trigger levels or ranges of the discharge circuits are varied so as to coordinate the timing of the control of the discharge circuits to form the respective current paths.

The controller may be configured to selectively control the switching of the discharge switching elements of the discharge circuits to form the respective current paths at the same time or at different times. The timing of the formations of the respective current paths can be varied to suit a wide range of energy discharging requirements.

The controller may be configured to selectively control the switching of the discharge switching elements of the discharge circuits to alternate or cycle between the formation of the respective current paths. The rate of alternating or cycling between the formation of the respective current paths may be defined by the thermal time constants of components of the discharge circuits. Alternating or cycling between the formation of the respective current paths provides each discharge circuit with time to cool down after performing the discharging function, which is advantageous for safety and reliability reasons.

The electrical assembly may be a multi-phase electrical assembly, and the plurality of discharge circuits are configured to be associated with a common phase or different phases. The controller may be configured to selectively control the switching of the discharge switching elements of the discharge circuits associated with different phases to form the respective current paths associated with different phases at the same time or at different times.

It will also be appreciated that the use of the terms “first” and “second”, and the like, in this patent specification is merely intended to help distinguish between similar features (e.g. the first and second limb portions, the first and second current interruption devices, the first and second control units, and so on), and is not intended to indicate the relative importance of one feature over another feature, unless otherwise specified.

A preferred embodiment of the invention will now be described, by way of a non-limiting example, with reference to the accompanying drawings in which:

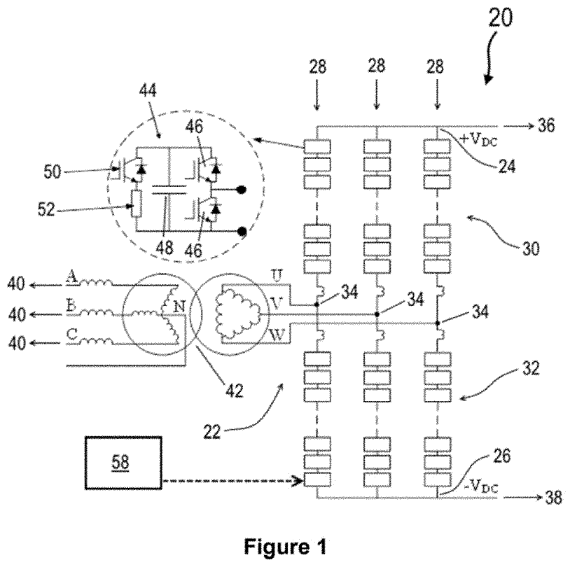

FIG. 1 shows schematically an electrical assembly according to a first embodiment of the invention;

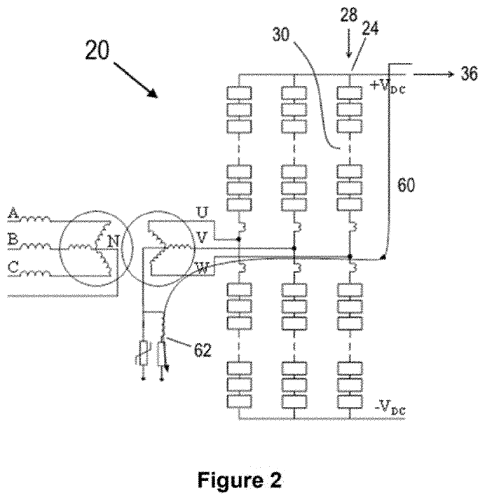

FIG. 2 illustrates a first discharge operation of the electrical assembly of FIG. 1;

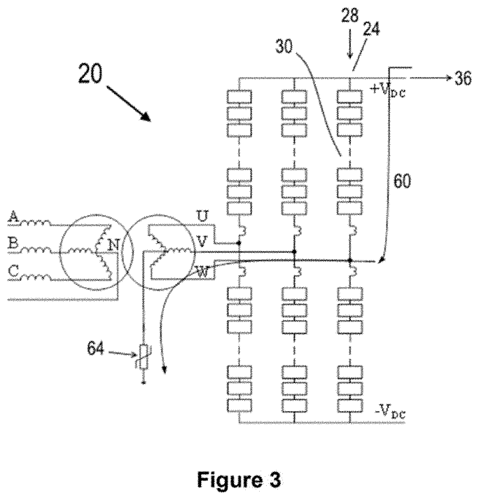

FIG. 3 illustrates a second discharge operation of the electrical assembly of FIG. 1;

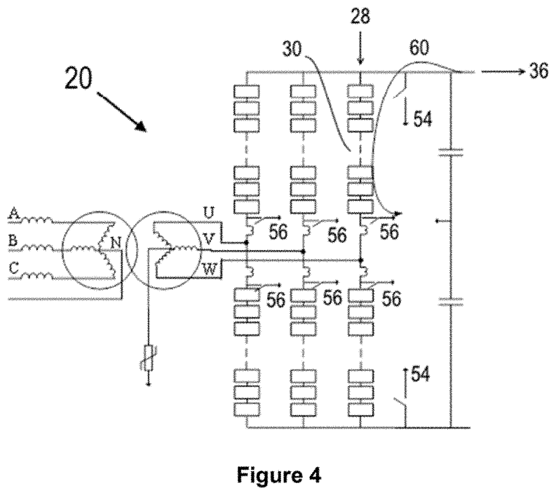

FIG. 4 illustrates a third discharge operation of the electrical assembly of FIG. 1;

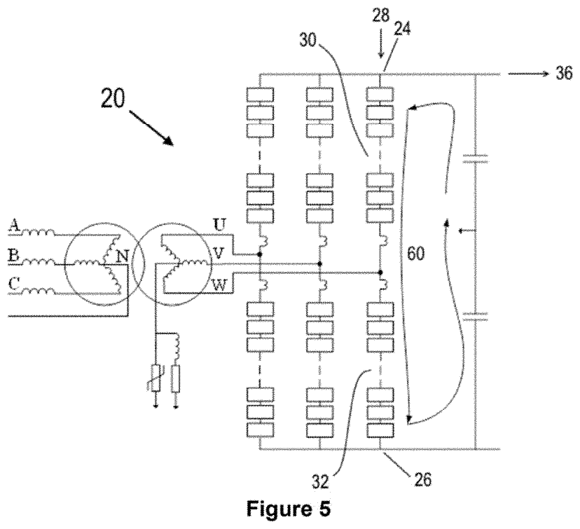

FIG. 5 illustrates a fourth discharge operation of the electrical assembly of FIG. 1;

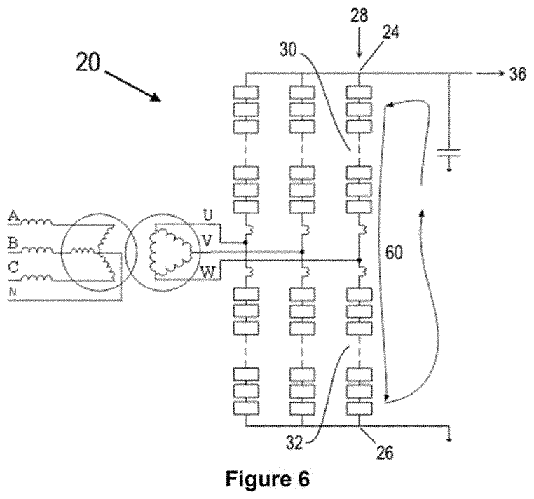

FIG. 6 illustrates a fifth discharge operation of the electrical assembly of FIG. 1;

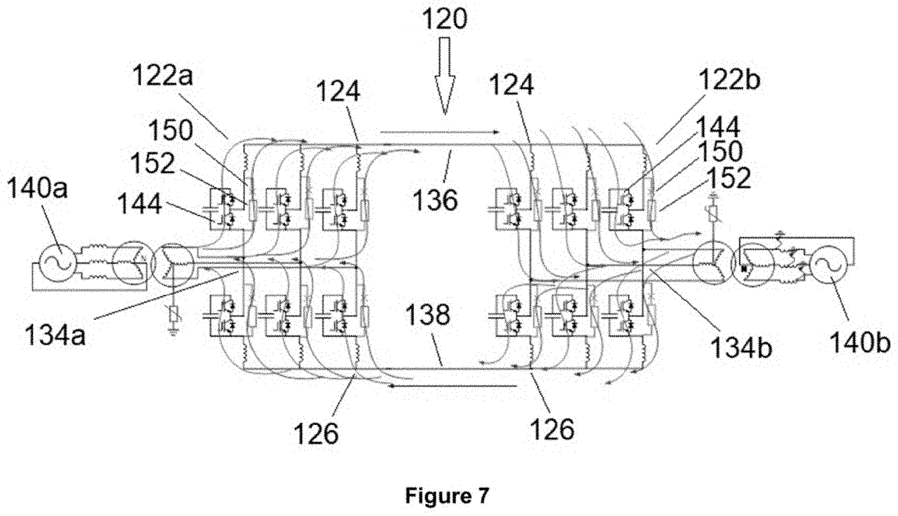

FIG. 7 shows schematically an electrical assembly according to a second embodiment of the invention; and

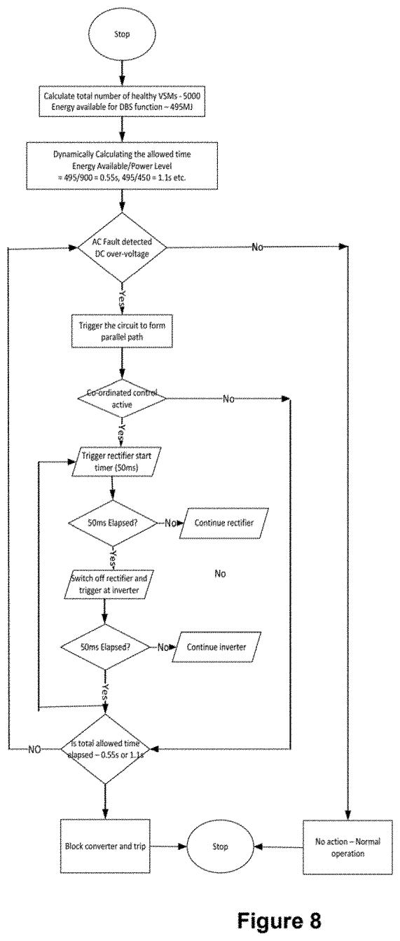

FIG. 8 illustrates a flow chart of a fault operation of the electrical assembly of FIG. 7.

The figures are not necessarily to scale, and certain features and certain views of the figures may be shown exaggerated in scale or in schematic form in the interests of clarity and conciseness.

The following embodiments of the invention are used primarily in HVDC applications, but it will be appreciated that the following embodiments of the invention are applicable mutatis mutandis to other applications operating at different voltage levels.

An electrical assembly according to a first embodiment of the invention is shown in FIG. 1 and is designated generally by the reference numeral 20.

The electrical assembly 20 includes a voltage source converter 22.

The voltage source converter 22 includes first and second DC terminals 24,26 and a plurality of converter limbs 28. Each converter limb 28 extends between the first and second DC terminals 24,26 and includes first and second limb portions 30,32 separated by a respective AC terminal 34. In each converter limb 28, the first limb portion 30 extends between the first DC terminal 24 and the AC terminal 34, while the second limb portion 32 extends between the second DC terminal 26 and the AC terminal 34.

In use, the first and second DC terminals 24,26 of the voltage source converter 22 are respectively connected to first and second DC power transmission media 36,38 connected to a DC network. In use, the AC terminal 34 of each converter limb 28 of the voltage source converter 22 is connected to a respective AC phase of a three-phase AC network 40 via a star-delta transformer arrangement 42 and a respective AC circuit interruption device (not shown) in the form of an AC circuit breaker. The electrical assembly 20 further includes a control unit (not shown) for operating the AC circuit breakers to open or close.

The star-delta transformer arrangement 42 may be replaced by a star-star transformer arrangement.

Each limb portion 30,32 includes a chain-link converter that is defined by a plurality of series-connected switching modules 44. FIG. 1 shows schematically the structure of each switching module 44.

Each switching module 44 includes a pair of module switching elements 46 and a capacitor 48. The pair of module switching elements 46 are connected in parallel with the capacitor 48 in a half-bridge arrangement to define a 2-quadrant unipolar module that can provide zero or positive voltage and can conduct current in both directions.

Each module switching element 46 is in the form of an insulated gate bipolar transistor (IGBT) which is connected in parallel with an anti-parallel diode.

It is envisaged that, in other embodiments of the invention, each IGBT may be replaced by a gate turn-off thyristor, a field effect transistor, an injection-enhanced gate transistor, an integrated gate commutated thyristor or any other self-commutated semiconductor device. It is also envisaged that, in other embodiments of the invention, each diode may be replaced by a plurality of series-connected diodes.

The capacitor 48 of each switching module 44 is selectively bypassed or inserted into the corresponding chain-link converter by changing the states of the module switching elements 46. This selectively directs current through the capacitor 48 or causes current to bypass the capacitor 48, so that the switching module 44 provides a zero or positive voltage.

The capacitor 48 of the switching module 44 is bypassed when the module switching elements 46 in the switching module 44 are configured to form a short circuit in the switching module 44, whereby the short circuit bypasses the capacitor 48. This causes current in the corresponding chain-link converter to pass through the short circuit and bypass the capacitor 48, and so the switching module 44 provides a zero voltage, i.e. the switching module 44 is configured in a bypassed mode.

The capacitor 48 of the switching module 44 is inserted into the corresponding chain-link converter when the module switching elements 46 in the switching module 44 are configured to allow the current in the corresponding chain-link converter to flow into and out of the capacitor 48. The capacitor 48 then charges or discharges its stored energy so as to provide a positive voltage, i.e. the switching module 44 is configured in a non-bypassed mode.

In this manner the module switching elements 46 in each switching module 44 are switchable to control flow of current through the corresponding capacitor 48.

It is possible to build up a combined voltage across each chain-link converter, which is higher than the voltage available from each of its individual switching modules 44, via the insertion of the capacitors of multiple switching modules 44, each providing its own voltage, into each chain-link converter. In this manner switching of the module switching elements 46 in each switching module 44 causes each chain-link converter to provide a stepped variable voltage source, which permits the generation of a voltage waveform across each chain-link converter using a step-wise approximation. Hence, the module switching elements 46 in each limb portion 30,32 are switchable to selectively permit and inhibit flow of current through the corresponding capacitor 48 in order to control a voltage across the corresponding limb portion 30,32.

It is envisaged that, in other embodiments of the invention, each switching module 44 may be replaced by another type of switching module, which includes a plurality of module switching elements and at least one energy storage device, the plurality of module switching elements and the or each energy storage device in each such switching module being arranged to be combinable to selectively provide a voltage source.

It is also envisaged that, in other embodiments of the invention, the capacitor 48 in each switching module 44 may be replaced by another type of energy storage device which is capable of storing and releasing energy to provide a voltage, e.g. a battery or a fuel cell.

Each switching module 44 further includes a discharge circuit in the form of a series connection of a discharge switching element 50 and a discharge resistor 52. In each switching module 44, the series connection of the discharge switching element 50 and the discharge resistor 52 is connected in parallel with the capacitor 48 such that the discharge switching element 50 is switchable to switch the discharge resistor 52 into and out of the switching module 44. In use, each discharge resistor 52 may be switched into the corresponding switching module 44 to selectively discharge energy stored in the capacitor 48. This may be used to rapidly discharge the capacitor 48 in order to, for example, provide fast access to the switching module 44 for repair or maintenance.

It is envisaged that, in other embodiments of the invention, the discharge switching element and the discharge resistor may be arranged differently in the discharge circuit. It is also envisaged that, in still other embodiments of the invention, the discharge circuit may include a different number of discharge switching elements and/or a different number of discharge resistors.

The voltage source converter 22 also includes grounding connections arranged at the AC sides and DC sides of the voltage source converter 22. More specifically, a respective DC side grounding connection 54 is connected between each DC terminal 24,26 and the plurality of converter limbs 28, and each limb portion 30,32 includes an AC side grounding connection 56 connected between the switching modules 44 and the AC terminal 34. Each grounding connection 54,56 includes a grounding switching element which is switchable to selectively connect the voltage source converter 22 to ground.

The voltage source converter 22 further includes a controller 58 programmed to control the switching of the module switching elements 46, discharge switching elements 50, and grounding switching elements.

In order to transfer power between the DC and AC networks 40, the controller 58 controls the switching of the module switching elements 46 of the switching modules 44 to switch the respective limb portions 30,32 into and out of circuit between the respective DC and AC terminals 24,26,34 to interconnect the DC and AC networks 40. When a given limb portion 30,32 is switched into circuit between the respective DC and AC terminals 24,26,34, the controller 58 switches the module switching elements 46 of the switching modules 44 of the given limb portion 30,32 to provide a stepped variable voltage source and thereby generate a voltage waveform so as to control the configuration of an AC voltage waveform at the corresponding AC terminal 34 to facilitate the transfer of power between the DC and AC networks 40.

To generate a positive AC voltage component of an AC voltage waveform at the AC terminal 34 of a given converter limb 28, the first limb portion 30 is connected into circuit between the first DC terminal 24 and the corresponding AC terminal 34, and the second limb portion 40 is switched out of circuit between the second DC terminal 26 and the corresponding AC terminal 34.

To generate a negative AC voltage component of an AC voltage waveform at the AC terminal 34 of a given converter limb 28, the first limb portion 30 is switched out of circuit between the first DC terminal 24 and the corresponding AC terminal 34, and the second limb portion 32 is connected into circuit between the second DC terminal 26 and the corresponding AC terminal 34.

A fault may occur in the voltage source converter 22 or the DC power transmission media 36,38, which results in one of the DC power transmission media 36,38 experiencing an increase in voltage to twice the value of its normal operating voltage. For ease of reference, the DC power transmission medium 36,38 experiencing an increase in voltage to twice the value of its normal operating voltage will be referred to hereon as the faulty DC power transmission medium. Upon detection of the occurrence of the fault, a protection sequence is initiated. The protection sequence is described as follows with reference to FIGS. 2 to 6.

Initially the module switching elements 46 are switched to block the voltage source converter 22, and the AC circuit breakers are opened to isolate the voltage source converter 22 from the AC network 40. The discharge switching elements 50 of the switching modules 44 are then switched to form a current path 60 in the voltage source converter 22, where the current path 60 includes a plurality of discharge resistors 52 switched into the voltage source converter 22. The purpose of the current path 60 is to provide a path for a discharging current to flow from the faulty DC power transmission medium 36,38 to a lower electrical potential, so that the discharge resistors 52 can dissipate the energy stored in the faulty DC power transmission medium 36,38 and thereby enable the voltage of the DC power transmission medium 36,38 to drop to a target value, preferably to zero. The time taken for the voltage of the DC power transmission medium 36,38 to drop to the target value depends on the time constant of the current path 60.

The exact configuration of the current path 60 depends on the discharge requirements of the faulty DC power transmission medium 36,38. The following discharge operations are described with reference to the first DC power transmission medium 36 as the faulty DC power transmission medium, but it will be appreciated that the following discharge operations apply mutatis mutandis to the second DC power transmission medium 38 as the faulty DC power transmission medium.

FIG. 2 illustrates a first discharge operation of the electrical assembly 20. In FIG. 2, the current path 60 extends from the first DC terminal 24, through a first limb portion 30 of one of the converter limbs 28, and through a series connection 62 of a grounding reactor and a grounding resistor operably connected to the AC terminal 34 of the converter limb 28. This allows the discharging current to flow through the switched-in discharging resistors 52 so as to dissipate the energy stored in the faulty DC power transmission medium 36.

FIG. 3 illustrates a second discharge operation of the electrical assembly 20. In FIG. 3, the current path 60 extends from the first DC terminal 24, through a first limb portion 30 of one of the converter limbs 28, and through a grounding surge arrester 64 operably connected to the AC terminal 34 of the converter limb 28. When the discharging current flows through the grounding surge arrester 64, the energy stored in the faulty DC power transmission medium 36 will be discharged until a voltage of the faulty DC power transmission medium 36 reaches a protective level of the grounding surge arrester 64.

FIG. 4 illustrates a third discharge operation of the electrical assembly 20. In FIG. 4, a grounding switching element is switched to connect the current path 60 to ground via a first limb portion 30 of one of the converter limbs 28 and the corresponding AC side grounding connection 56. This allows the discharging current to flow through the switched-in discharging resistors 52 so as to dissipate the energy stored in the faulty DC power transmission medium 36. The third discharge operation preferably takes place after the second discharge operation so that the third discharge operation enables the remaining energy stored in the faulty DC power transmission medium 36 to drop to zero.

It will be understood that any of the grounding connections 54,56 may be utilised to connect the current path 60 to ground, which would depend on the configuration of the current path 60 within the voltage source converter 22.

FIG. 5 illustrates a fourth discharge operation of the electrical assembly 20. In FIG. 5, the current path 60 extends from the first DC terminal 24, through both the first and second limb portions 30,32 of one of the converter limbs 28, and to the second DC terminal 26. This allows the discharging current to flow through the switched-in discharging resistors 52 in both the first and second limb portions 30,32 so as to dissipate the energy stored in the faulty DC power transmission medium 36. This is particularly relevant for use with a symmetrical monopole DC network.

FIG. 6 illustrates a fifth discharge operation of the electrical assembly 20. In FIG. 6, the current path 60 extends from the first DC terminal 24, through both the first and second limb portions 30,32 of one of the converter limbs 28, and to the second DC terminal 26. This allows the discharging current to flow through the switched-in discharging resistors 52 in both the first and second limb portions 30,32 so as to dissipate the energy stored in the faulty DC power transmission medium 36. This is particularly relevant for use with an asymmetrical monopole DC network.

The configuration of the electrical assembly 20 of FIG. 1 therefore enables fast discharge of the energy stored in the faulty DC power transmission medium 36 through the control of the discharge circuits internal to the voltage source converter 22. In addition, the configuration of the electrical assembly 20 of FIG. 1 also provides cost and size savings in comparison to a conventional electrical assembly with dedicated discharge circuits which are connected to the DC power transmission media and external to the voltage source converter.

An electrical assembly according to a second embodiment of the invention is shown in FIG. 7 and is designated generally by the reference numeral 120.

The electrical assembly 120 comprises voltage source converters in the form of a rectifier 122a and an inverter 122b.

Each voltage source converter 122a,122b of the second embodiment is similar in structure and configuration to the voltage source converter 22 of the first embodiment except that, in each voltage source converter 122a,122b of the second embodiment, each discharge circuit is connected in parallel with the corresponding switching module 144 such that, in use, the discharge switching element 150 is switchable to switch the discharge resistor 152 into the voltage source converter 122a,122b to form a parallel current path through which a converter current may flow. Additionally, in use, each discharge resistor 152 may be switched into circuit with the corresponding switching module 144 to enable selective discharge of energy stored in the capacitor.

For simplicity of illustration, FIG. 7 depicts the plurality of series-connected switching modules in each converter limb as a single switching module 144.

In use, the first and second DC terminals 124,126 of each of the rectifier 122a and inverter 122b are respectively connected to first and second DC power transmission media 136,138 such that the DC terminals 124,126 of the rectifier 122a and inverter 122b are interconnected via the DC power transmission media 136,138. In use, the AC terminal 134a of each converter limb of the rectifier 122a is connected to a respective AC phase of a first three-phase AC network 140a via a first AC power transmission medium, a star-star transformer arrangement 142a and a respective first AC circuit interruption device (not shown) in the form of an AC circuit breaker. In use, the AC terminal 134b of each converter limb of the inverter 122b is connected to a respective AC phase of a second three-phase AC network 140b via a second AC power transmission medium, a star-star transformer arrangement 142b and a respective second AC circuit interruption device (not shown) in the form of an AC circuit breaker. The electrical assembly 120 further includes a first control unit (not shown) for operating the first AC circuit breakers to open or close, and a second control unit (not shown) for operating the second AC circuit breakers to open or close.

In order to transfer power from the first AC network 140a to the second AC network 140b, the controller 158 controls the switching of the module switching elements of the switching modules 144 of each voltage source converter 122a,122b to switch the respective limb portions into and out of circuit between the respective DC and AC terminals 24,26,134a,134b to interconnect the DC and AC sides of each voltage source converter 122a,122b.

A fault or disturbance may occur in either or both of the first and second AC networks 140a,140b. The fault or disturbance may result in: a DC over-voltage in either or both of the DC power transmission media 136,138; an AC over-frequency, an overcurrent and/or a power swing in the first and second AC networks 140a,140b; and/or an imbalance between a power fed to the electrical assembly 120 by the first AC network 140a and a power demanded of the electrical assembly 120 by the second AC network 140b.

Under certain circumstances, it is desirable for the electrical assembly 120 to ride through the fault or disturbance for as long as possible in order to adhere to grid codes that require the electrical assembly 120 to stay online. For example, when the first AC network 140a includes one or more renewable energy sources (such as wind and solar), the or each renewable energy source is not permitted to trip but instead is required to stay online and provide fault ride through support even when there are significant voltage drops in the second AC network 140b.

For the purposes of non-limiting illustration, a protection sequence is described with reference to the fault or disturbance occurring in the second AC network 140b resulting in a power fed to the electrical assembly 120 by the first AC network 140a exceeding a power demanded of the electrical assembly 120 by the second AC network 140b. This imbalance between the fed power and the demanded power results in a DC over-voltage in either or both of the DC power transmission media 136,138. Upon detection of the occurrence of the fault or disturbance, the protection sequence is initiated to perform a discharging operation in order to dissipate excess power fed to the electrical assembly 120.

The protection sequence is described as follows with reference to FIG. 8.

In response to the detection of the DC over-voltage, the discharge circuits of the rectifier 122a and inverter 122b are controlled to form respective parallel current paths in the respective voltage source converters 122a,122b, where each parallel current path includes a plurality of discharge resistors 152 switched into the respective voltage source converter 122a,122b. At the same time, converter currents are allowed to continue flowing through the switching modules 144.

The purpose of each parallel current path is to provide a path for a discharging current to flow through the switched-in discharge resistors 152 so that the switched-in discharge resistors 152 can dissipate the energy stored in the associated power transmission media 136,138 in order to dissipate excess power fed to the electrical assembly 120.

Meanwhile the electrical assembly 120 is configured to stay online by switching the module switching elements to maintain the voltage source converters 122a,122b in a de-blocked state and by keeping the first and second AC circuit breakers closed to maintain the electrical connection of the voltage source converters 122a,122b to the first and second AC networks 140a,140b.

The discharge circuits of the rectifier 122a and inverter 122b are controlled to alternate between the formation of the parallel current paths in the rectifier 122a and the formation of the parallel current paths in the inverter 122b. The rate of alternating between the formation of the parallel current paths in the rectifier 122a and the formation of the parallel current paths in the inverter 122b is defined by the thermal time constants of components of the discharge circuits.

In the protection sequence shown in FIG. 8, the formation of the parallel current paths alternates between the rectifier 122a and inverter 122b, with each of the rectifier 122a and inverter 122b being controlled to form the respective parallel current paths for a respective exemplary period of 50 ms. This provides the discharge circuits of each voltage source converter 122a,122b with a period of 50 ms to cool down before reforming the parallel current paths to dissipate more energy.

If the fault or disturbance clears before an allowable duration of forming the parallel current paths lapses, the electrical assembly 120 is permitted to continue its normal power transfer operation.

If a duration of the fault or disturbance exceeds an allowable duration of forming the parallel current paths, the module switching elements are switched to block the voltage source converters 122a,122b, and the first and second AC circuit breakers are opened to isolate the voltage source converters 122a,122b from the first and second AC networks 140a,140b.

Prior to the initiation of the protection sequence, the controller 158 assesses the number and energy ratings of the discharge circuits in order to determine the amount of energy discharging capacity available to perform the discharging operation. The controller determines the allowable duration of forming the parallel current paths by dividing the amount of energy discharging capacity available to perform the discharging operation with the power transfer level of the electrical assembly 120.

Optionally the controller 158 may be configured to control the switching of the discharge switching elements 150 of the discharge circuits to form the respective parallel current paths by varying a respective DC voltage trigger level at which each discharge circuit is controlled to form the respective parallel current path, so as to coordinate the timing of the control of the discharge circuits to form the respective parallel current paths in the rectifier 122a and inverter 122b. This enables the electrical assembly 120 to control the distribution of the discharging function between the rectifier 122a and inverter 122b, and enable the inverter 122b to readily provide reactive power support to the second AC network 140b. Each DC voltage trigger level is preferably defined by the resistance of the DC power transmission media 136,138, the amount of energy discharging capacity available to perform the discharging operation, and the amount of energy allowed to flow into the second AC network 140 and required to provide reactive power support.

Further optionally, the controller 158 may be configured to selectively control the switching of the discharge switching elements 150 of the discharge circuits associated with different phases to form the respective parallel current paths associated with different phases at the same time or at different times.

In other embodiments of the invention, the electrical assembly 120 may be modified such that the discharging operation is carried out by the discharge circuits of either of the rectifier 122a and inverter 122b, but not both.

The configuration of the electrical assembly 120 of FIG. 7 therefore enables dissipation of excess power fed to the electrical assembly 120, arising from a fault or disturbance in the AC networks 140a,140b, through the control of the discharge circuits internal to the voltage source converters 122a,122b. In addition, the configuration of the electrical assembly 120 of FIG. 7 provides cost and size savings in comparison to a conventional electrical assembly with a dedicated discharge circuit (e.g. a conventional dynamic braking resistor) which are connected to the DC power transmission media and external to the voltage source converters.

In other embodiments of the invention, the protection sequence may be initiated in response to another way of detecting the occurrence of the electrical fault or disturbance, such as detection of an AC over-frequency, an overcurrent and/or a power swing in the first and second AC networks 140a,140b.

It will be appreciated that the various configurations of the switching modules 44,144 and discharge circuits described in this specification are interchangeable and thereby applicable to the different embodiments of the invention described in this specification. In addition, as stated above, it will be understood that it is not essential for the or each discharge circuit to form part of a switching module 44,144.

1-41. (canceled)

42. An electrical assembly for interconnecting first and second networks, the electrical assembly comprising a power transmission medium and a converter, the power transmission medium configured for connection to the first network, the converter including:
a first terminal and a second terminal, the first terminal connected to the power transmission medium, the second terminal configured for connection to the second network;
at least one switching module arranged to interconnect the first terminal and the second terminal, the or each switching module switchable to control a transfer of power between the first and second networks;
at least one discharge circuit including a discharge switching element and a discharge resistor, the or each discharge switching element switchable to switch the corresponding discharge resistor into and out of the converter; and
a controller configured to selectively control the switching of the or each discharge switching element to form a current path in the converter, the current path including the or each discharge resistor, so that a discharging current flows through the current path to discharge an energy stored in the power transmission medium.

43. The electrical assembly according to claim 42 wherein the controller is configured to selectively control the switching of the or each switching module to de-block the converter or maintain the converter in a de-blocked state prior to the control of the switching of the or each discharge switching element to form the current path.

44. The electrical assembly according to claim 42 wherein the electrical assembly is configured to maintain electrical connection of the converter to the first and second networks when the or each discharge circuit is controlled to form the current path.

45. The electrical assembly according to claim 44 including a first circuit interruption device connected to the first terminal and configured for connection to the first network, wherein the electrical assembly includes a first control unit configured to selectively operate the first circuit interruption device to maintain the electrical connection between the converter and the first network when the or each discharge circuit is controlled to form the current path.

46. The electrical assembly according to claim 44 including a second circuit interruption device connected to the second terminal and configured for connection to the second network, wherein the electrical assembly includes a second control unit configured to selectively operate the second circuit interruption device to maintain the electrical connection between the converter and the second network when the or each discharge circuit is controlled to form the current path, wherein the controller is configured to selectively control the switching of the or each discharge switching element to connect the current path to the second terminal so that the discharging current flows to the second terminal, the electrical assembly including at least one impedance element operably connected to the second terminal, wherein the or each impedance element includes a linear resistive element, a non-linear resistive element and/or a reactance element.

47. The electrical assembly according to claim 42 wherein the or each switching module includes at least one module switching element and at least one energy storage device, the or each module switching element and the or each energy storage device in the or each switching module arranged to be combinable to selectively provide a voltage source, wherein the or each discharge circuit is arranged in the switching module or a respective one of the switching modules.

48. The electrical assembly according to claim 42 wherein the converter includes one or more grounding connections, the or each grounding connection including a grounding switching element switchable to selectively connect the converter to ground, and the controller is further configured to selectively control the switching of the or each grounding switching element to connect the current path to ground via the or each grounding connection.

49. An electrical assembly according to claim 48, wherein the or each impedance element includes a non-linear resistive element, and the controller is configured to selectively control the switching of the or each discharge switching element and the or each grounding switching element to connect the current path to the second terminal so that the discharging current flows through the or each impedance element followed by connecting the current path to ground via the or each grounding connection.

50. The electrical assembly according to claim 42 wherein the controller is configured to determine an allowable duration of forming the current path, wherein the allowable duration is determined as a function of a power transfer level of the electrical assembly, an amount of power required to be dissipated by the or each discharge circuit and/or an energy rating of the or each discharge circuit.

51. The electrical assembly according to claim 50 wherein the controller is configured to selectively control the switching of the or each switching module to block the converter in response to a duration of an electrical fault or disturbance associated with the electrical assembly exceeding the allowable duration of forming the current path.

52. The electrical assembly according to claim 50 including a first circuit interruption device connected to the first terminal and configured for connection to the first network, wherein the electrical assembly includes a first control unit configured to selectively operate the first circuit interruption device to disconnect the converter from the first network in response to a duration of an electrical fault or disturbance associated with the electrical assembly exceeding the allowable duration of forming the current path.

53. The electrical assembly according to claim 52 including a second circuit interruption device connected to the second terminal and configured for connection to the second network, wherein the electrical assembly includes a second control unit configured to selectively operate the second circuit interruption device to disconnect the converter from the second network in response to a duration of an electrical fault or disturbance associated with the electrical assembly exceeding the allowable duration of forming the current path.

54. The electrical assembly according to claim 42 wherein the converter includes a plurality of discharge circuits, and the controller is configured to selectively control the switching of the discharge switching elements of the discharge circuits to form respective current paths in the converter.

55. The electrical assembly according to claim 42 including a plurality of converters, each converter including at least one discharge circuit, wherein the controller is configured to selectively control the switching of the discharge switching elements of the discharge circuits to form respective current paths in the respective converters.

56. The electrical assembly according to claim 55 wherein a first one of the plurality of converters is configured as a rectifier, and a second one of the plurality of converters is configured as an inverter.

57. The electrical assembly according to claim 56 wherein the first terminal of the rectifier is an AC terminal, the second terminal of the rectifier is a DC terminal, the first terminal of the inverter is a DC terminal, and the second terminal of the inverter is an AC terminal.

58. The electrical assembly according to claim 57 wherein the controller is configured to control the switching of the discharge switching elements of the discharge circuits to form the respective current paths by varying a respective trigger level or range at which each discharge circuit is controlled to form the respective current path.

59. The electrical assembly according to claim 58 wherein the trigger levels or ranges of the discharge circuits are varied so as to coordinate the control of the discharge circuits to form the respective current paths.

60. The electrical assembly according to claim 59 wherein the trigger levels or ranges of the discharge circuits are varied so as to coordinate the timing of the control of the discharge circuits to form the respective current paths.

61. The electrical assembly according to claim 60 wherein the controller is configured to selectively control the switching of the discharge switching elements of the discharge circuits to alternate or cycle between the formation of the respective current paths.
